(19) United States
(12) Patent Application Publication
(10) Pub. No.: US 2003/0052799 A1
(43) Pub. Date: Mar. 20, 2003

(54) Aircraft security system to prevent manual flight operation by unauthorized individuals

(76) Inventor: Adolf Weigl, Englewood, FL (US)

Correspondence Address: CHRISTIE, PARKER & HALE, LLP, 350 WEST COLORADO BOULEVARD, SUITE 500, PASADENA, CA, 91105, US

(21) Appl. No.: 09/972,018

(22) Filed: Oct. 4, 2001

(30) Foreign Application Priority Data
Sep. 19, 2001 (DE) 101 46 170.4

(51) Int. Cl. G08B 21/00

(52) U.S. Cl. 340/945; 340/574; 340/540

(57) ABSTRACT

The security system has means (3) to detect specific physical characteristics, in particular the weight of the pilot. Moreover, means (11-14) are present to prevent activation of manual flight operation or to switch from manual to automatic flight operation or to deactivate manual flight operation, if the physical characteristics detected by the detection means (3) do not match predefined physical characteristics. In this manner it is possible to prevent aircraft hijackers from taking control of the aircraft and approaching a target of their own selection.

The present invention concerns a security system for the control of an aircraft, in particular a civil passenger or freight aircraft, according to the generic portion of claim 1.

The terror strikes carried out recently with civil commercial airliners in the USA have triggered an intense discussion about how such strikes can be prevented in the future by technical means. It is necessary to prevent aircraft hijackers who are capable of controlling the aircraft from gaining control of the aircraft in order to fly it to a target selected by them and to cause disastrous destruction by intentional impact.

Improved security of the cockpit of the aircraft is being discussed as a possibility for improving security. In particular, a lockable cockpit door that can be unlocked only by special measures and/or only at specific times is being considered. This approach to a solution is, however, considered unsatisfactory in practice for various reasons. For one thing, the possibilities for evacuation of the aircraft essential in an emergency are reduced since, for the passengers or the crew, the way through the cockpit into the open is no longer readily available. For another, a locked cockpit door is of only limited use if aircraft hijackers located in the passenger compartment force the pilot to unlock the cockpit door by the threat of force against the passengers and the crew.

Consequently, the object of the present invention is to provide a technical device by means of which the control and steering of an aircraft by unauthorized individuals can be reliably prevented. Advantageous embodiments and improvements of the invention are reported in the dependent claims.

In many of today's passenger and freight aircraft, primary flight control systems that are supplied with electrical signals and usually referred to as “fly-by-wire” flight controls are used. Such electrical/electronic systems have converter elements that convert the mechanical movement generated with the control devices located in the cockpit (wheel, stick, and pedals) into electrical pulses. These are merged via electrical connecting lines in a central flight computer and are fed from there in turn via electrical connecting lines to the control surfaces of the aircraft (ailerons, elevators, rudders). The electrical connecting lines leading to the control surfaces are connected to electrical-mechanical converters in which the electrical pulses are transformed into mechanical movements to drive the control surfaces.

In addition, an autopilot-primary flight computer can be provided in which destination coordinates and the air route and the like can be entered. When the autopilot is activated, by means thereof, either the control devices located in the cockpit are moved, positioned, and stopped by themselves or by downstream mechanical elements decoupled from the control devices. In any case, upon activation of the autopilot, manual control of the aircraft by operation of the control devices located in the cockpit is no longer possible.

The above described “fly-by-wire” the control system with additional autopilot is described, for example, in the European patent EP 0 885 411 B1, which is hereby included in its totality in the disclosed content of the present application.

An aircraft takeoff-landing sequence performable using such a control system is, for example, represented by the following process steps—presented in a simplified matter (without consideration of the aircraft's power package).

1. Main switch set on ON

2. Input of destination coordinates autopilot

3. Autopilot set on OFF

4. Manual control set on ON

5. Take-off

6. Switch autopilot from OFF to ON→(flight)

7. Switch autopilot from ON to OFF

8. Landing, manual

9. Main switch set on OFF.

The switching between the automatic (autopilot) and manual control states usually occurs by means of a simple switch provided for this on one of the pilot's control consoles.

An essential idea of the present invention consists in enabling manual flight operation only under compliance with specific predefined and electrically/electronically verifiable conditions. These conditions are such that in a given situation virtually only the pilot is capable of switching the control system into manual flight operation and maintaining this state.

The security system according to the invention ensures that in the event of noncompliance with the conditions, activation of manual flight operation is prevented; or in the event of manual operation already activated, switching from manual to automatic operation or to deactivation of the manual flight operation is carried out.

The conditions for initiating manual flight operation provided for according to the invention are defined by specific physical characteristics, which can be represented in practice and in a given situation only by the pilot. Specific physical characteristics of the pilot must, consequently, be stored in some form and compared in a given situation with physical characteristics of an operator, whereupon the flight computer must decide whether or not manual flight operation can be enabled for the operator.

The physical characteristics of the pilot may be stored before takeoff of the aircraft in a memory unit of the flight computer. These characteristics may, for example, be stored in digital form on a diskette and entered into the flight computer before the takeoff of the aircraft. In most cases, it would, however, probably prove to be more advantageous to detect the physical characteristics of the pilot during a so-called initialization phase before takeoff of the aircraft using appropriate sensor devices and to transmit the data and/or values determined by the sensor devices to the memory unit of the flight computer.

An advantageous embodiment of the invention consists in that the physical characteristics are determined by the weight of the pilot. Since the weight of an individual is variable over the course of time, it is advantageous in this case to determine the weight of the pilot during the initialization phase before the takeoff of the aircraft. For this, a scale, by means of which the weight of the operator sitting in the pilot's seat is detected and electronically communicated to the flight computer, is advantageously integrated into the pilot's seat. Thus, before the takeoff of the aircraft, the weight of the pilot is measured and stored in the flight computer. If, subsequently, manual flight operation is to be activated, the weight on the seat scale is again detected and compared with the previously measured and stored weight of the pilot.

If the values to be compared differ by only a predefined tolerance range, the manual flight operation is enabled. However, as soon as the weight values to be compared differ by more than the tolerance range, switchover to manual flight operation is blocked.

Thus, provision can be made in the security system that not only a blocking of the switchover from automatic to manual flight operation is enabled, but also that during manual flight operation, the current weight of the operator on the seat scale is measured at specific time intervals, possibly averaged over several measured values, and compared with the stored value. If the deviation thus determined is significantly greater than the aforementioned tolerance range, the preset manual flight operation is deactivated and the system is possibly returned to automatic flight operation (autopilot).

By means of the present invention, it is thus possible in the event of the hijacking of an aircraft to prevent the hijacker(s) from taking over control of the aircraft after removal of the pilot and the copilot and attacking a target of their own choice under manual control. The hijackers will, as a rule, have no one among them who has approximately the same weight as the pilot. Consequently, when one of the hijackers sits in the pilot's seat after removal of the pilot, the security system according to the invention determines that his weight deviates significantly from the stored value of the weight of the pilot and then rejects the transition to manual flight operation. However, if manual flight operation has already been set and the hijacker sits down in place of the pilot in the pilot's seat to control the aircraft; as a result of the measurement of his weight performed at relatively short time intervals, it is determined after a short time that this does not match the stored weight value for the pilot and, as a result, a command is triggered whereby manual flight operation is terminated and the system returns to automatic flight operation, i.e., to the autopilot state.

Obviously, it must under all circumstances be prevented for a manual operating state set by the pilot to be left because of the system and for a change to the automatic operating state to be made. Due to posture related shifts in the weight of the pilot in the pilot's seat, it may, for example, occur that from time to time an incorrect weight is measured and communicated by the seat scale. This can be countered in that the weight is measured repeatedly at regular time intervals and is averaged over a plurality of measured values. In addition, or alternatively, it is also possible to wait a specific amount time before a decision concerning the switchover, until it is determined with certainty that the weight has significantly changed.

Virtually all existing aircraft can be controlled manually only from the sitting position in the pilot's seat. If the pilot remains in the pilot's seat, a switchover into the manual operating state based on a correct weight determination is, to be sure, possible; however, for manual control, it is then essential to remove the pilot from the pilot's seat and to assume a sitting position therein. For the reasons already described, the security system then returns automatically from the manual operating state to the autopilot state.

The security system according to the invention is based on the fact that an autopilot is present. However, it is not absolutely essential that a “fly-by-wire” control be present. In principle, it may also be used in aircraft without such electrical/electronic control.

The possibility must also be considered that one of the two pilots may be unable for natural reasons (nausea, heart attack) to perform his duties during the flight and possibly may even have to leave his pilot's seat. In such an emergency situation, it is then essential that the remaining pilot be able to execute the flight and/or landing process alone. A technical possibility for overcoming this problem consists in that the secret code of the two pilots originally entered at the beginning of flight preparation enables the activation of the autopilot even without permanent occupation of the seat. It is assumed that in the event of a hijacking, a pilot who is still possibly alive and in the cockpit would not voluntarily betray the code to the hijackers and thus yield control of the aircraft completely to the hijackers.

Another reasonable addition to the security system according to invention could consist in that during the takeoff and landing phase, i.e., during phases in which the aircraft is in the manual operating state, the separating doors between the cockpit and passenger compartment are automatically locked from the inside, to thus permit no access to the cockpit during these periods.

The physical characteristics could also be other than the body weight of the pilot. Other conceivable identifying physical characteristics are, for example, the iris of the eye, the voice of the pilot, or even his fingerprint and/or handprint.

The pilot's iris can, for example, be recorded by an appropriately positioned video recording device (camera) and stored in an image file of the storage device of the flight computer. Then, if, subsequently, a switchover from automatic flight operation into manual flight operation is to be carried out, the iris of the operator who gave the order for the switchover to manual flight operation by actuation of the autopilot/manual toggle can be detected by one and the same camera. Then, an image file accordingly generated can be compared with the previously stored image file. If the manual operating state has already been set, the iris of the operator can be subsequently detected at regular time intervals and likewise compared with the stored data. Here again, a switchover into the manual mode of operation either does not occur or the system switches back from the already set manual mode of operation into the autopilot mode as soon as there are significant differences in the data to be compared.

The physical characteristics may further be provided by the voice of the pilot; however, in this case, a continuous monitoring during a preset manual operating state is somewhat problematic since the pilot would theoretically have to continually give voice samples to prove his authorization to the system.

Another possibility consists in that the physical characteristics could be provided by a fingerprint and/or a handprint of the pilot. However, the problem also exists here that the pilot would have to continually position a finger or hand at specific time intervals to prove his authorization.

However, even a plurality of the previously mentioned physical characteristics could be combined, whereby corresponding different detection means would have to be provided to detect the corresponding physical characteristics.

The essential characteristics of a security system according to the invention consist thus, according to everything previously stated, in means for the detection of physical characteristics of individuals and means to prevent the activation of manual flight operation or switchover from manual to automatic flight operation or to deactivate manual flight operation in the event the characteristics sensed by the detection means do not match predefined physical characteristics.

Depending on the type of physical characteristics to be detected and compared, the detection means consist either in a weight sensor, i.e., in particular in a scale integrated into the pilot's seat, an image recording device such as a camera, a microphone, or a fingerprint and/or handprint sensor for a combination of a plurality of the aforementioned devices.

The means to prevent activation of the manual flight operation could be included in the flight computer and appropriately connected electronically with the detection means. This could include a storage device to store data of physical characteristics as well as a comparison device to compare data from physical characteristics. It is possible to link an additional device for activation/deactivation of the autopilot operating state with these devices.

In the following, an exemplary embodiment of the security system according to the invention is explained in detail with reference to the drawings. They depict:

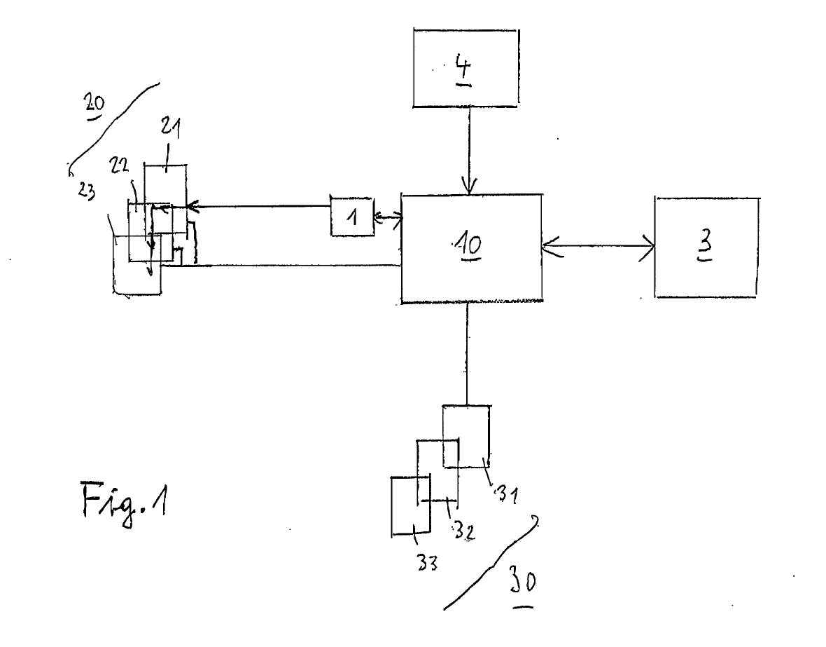

FIG. 1 a schematic block diagram of an electronic “fly-by-wire” control system of an aircraft, which includes a security system according to the invention;

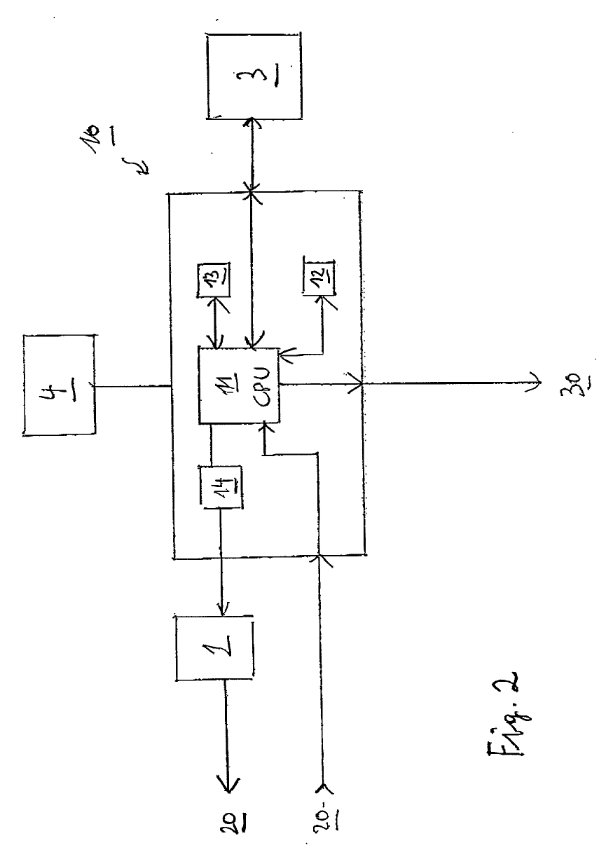

FIG. 2 a schematic block diagram of a security system according to the invention included in the control system; and

FIG. 3 a takeoff-landing sequence using a security system according to the invention.

FIG. 1 depicts a block diagram representing the principle of an electronic “fly-by-wire” flight controller, as is currently present in most commercial aircraft.

In the pilot's cockpit, control devices with which the pilot can operate the control surfaces of the aircraft are located. At his seat, the copilot has available the same control devices, which are mechanically linked with those of the pilot via a servo rod.

There are three control devices with which the aircraft can be moved around the three orthogonal axes. By rotating the wheel, the aileron attached to the wings is actuated. By tilting the stick on which the wheel is attached, the elevator is actuated. And finally, the rudder is moved by means of the pedals.

In “fly-by-wire” control systems, the mechanical movement of the control devices is converted by mechanical-electrical converters (not shown) into electrical pulses, which converge in a flight computer 10 and are forwarded from there to the various control surfaces. There they are converted by electrical-mechanical converters (not shown) into mechanical movements to drive the control surfaces.

In most aircraft, an autopilot-master computer 1 is also provided, which is either part of the flight computer 10 or is connected to the flight computer 10 as an independent data processing module. The destination coordinates of a destination to be flown to, as well as other data such as air route, flight corridor, and altitude, can be entered into the autopilot-master computer 1. When the autopilot master computer 1 is activated by the flight computer 10, it ensures, on the basis of these input data, that the control devices 20 are guided such that the aircraft maintains a desired air route. The actual geographic position of the aircraft may be determined at specific time intervals by a compass system or by the global positioning system (GPS) and fed to the autopilot-master computer 1, whereupon it issues appropriate commands to change the position of the control devices 20. In the event of activation of the autopilot-master computer 1, the control devices 20 can no longer be operated manually by the pilot.

In addition, according to prior art, additional operator functions, switch elements, and visual displays that is [sic! are] schematically depicted in the form of the control console 4 that is connected with the flight computer 10 are available to the pilot.

A characteristic essential to the invention consists in the detection means 3, which are likewise connected with the flight computer 10. In the already described preferred embodiment of the invention, the detection means 3 have an electronic scale incorporated into the pilot's seat, by which the weight of the operator sitting in the pilot's seat can be determined and forwarded to the flight computer 10. Provision can be made that by means of suitable software control of the flight computer 10, the weight is continuously determined at specific time intervals and is transmitted to the flight computer 10. This state of a continuous weight measurement can be activated in particular when the autopilot-master computer 1 is deactivated, i.e., manual flight operation is set. In this case, it is significant to continually monitor whether the operator performing the manual flight operation has the necessary authorization for this, whether, consequently, the operator has a body weight determined by the detection means 3 that corresponds to the body weight of the pilot.

FIG. 2 a depicts a block diagram of the principle, which illustrates the communication of the various components among each other.

The flight computer 10 has a processor CPU 11 through which all procedures and commands are coordinated. A storage device 12 in which personal data concerning the pilot and the copilot can be stored is connected to the CPU 11. In particular, data and values relative to the physical characteristics of the pilot and the copilot can be stored in the storage device 12. Preferably, such data are sensed by the detection means 3 in an initialization phase before takeoff and stored in the storage device 12. In the previously mentioned preferred application, in which the physical characteristics are provided by the body weight of the pilot, the weight of the pilot sitting in the pilot's seat is thus initially determined by the scale integrated into the pilot's seat and written via the CPU 11 into the storage device 12. Alternatively, the detection means 3 may also consist of an image detection device, a fingerprint/handprint sensor, or microphone, via which corresponding physical characteristics of the pilot such as the iris of one of his eyes, his fingerprint/handprint or his voice are detected and corresponding data are written into the storage device 12.

Provision can also be made that data concerning physical characteristics of the pilot are not detected and read in during an initial initialization phase, but that they are taken from an external storage medium or communicated via a radio connection from the outside and are written into the storage device 12.

The CPU 11 is further linked with a comparison device 13, in which data and values concerning physical characteristics sensed by the detection means 3 can be compared with such values stored in the storage device 12. In particular when a switch command for the switchover from automatic to manual flight operation is triggered on a switch of the control console for provided for this, the CPU 11 prompts a current measurement of physical characteristics such as weight by the detection means 3 and a comparison in the comparison device 13 of the currently measured value with the values stored in the storage device 12. Only when the comparison device 13 determines that the values to be compared are identical to each other within a specified tolerance range does it send a corresponding signal to the CPU 11, which thereupon causes an activation/deactivation unit 14 to deactivate the autopilot-master computer 1 such that manual flight operation is activated and the control devices 20 can be operated by the pilot.

When the autopilot-master computer 1 is deactivated, provision can be made that measured values of the detection means 3 are requested at specific time intervals and the measured values communicated are compared with the values stored in the storage device 12. As soon as a deviation in the values to be compared is detected, the CPU 11 prompts the activation/deactivation unit 14 to activate the autopilot-master computer 1 and thus to prevent manual flight operation. This can occur, for example, in that the measured values delivered by the detection means 3 are determined over relatively long intervals, such as a few seconds to a minute, and compared with the values stored. Only when there is a specific and significant deviation of the measured values delivered after a specific period of time, is manual flight operation prevented by the CPU 11 and the activation/deactivation unit 14 by activation of the autopilot-master computer 1. This should prevent, in the case of weight measurement, short-term fluctuations of the measured weight as a result of posture-related weight shifts of the pilot from making it impossible for him to be able to continue to perform manual flight operation.

FIG. 2 also depicts an electrical connection line coming from the control devices and connected with the flight computer 10, via which the electrical pulses of the control devices are communicated to the flight computer 10. The flight computer provides that these pulses are prepared appropriately and then forwarded to the control surfaces 30 of the aircraft.

An exemplary flow chart for a takeoff-landing sequence using a security system according to the invention is depicted in FIG. 3.

In the case of weight measurements, the aforementioned tolerance range can be ±1.5 or ±2 kg.

In addition, another capability can be present to deactivate the autopilot even without permanent occupation of the seat and to carry out manual flight operation. Provision can be made, for example, that the secret codes of the two pilots input originally at the beginning of flight preparation, which can be completely different for the pilot and copilot, can enable deactivation of the autopilot-master computer 1. This code may, for example, be entered via a keypad of the control console 4 and verified for correctness by the CPU 11, whereupon it permits the activator/deactivator unit 14 to deactivate the autopilot-master computer 1. This capability should be provided for those cases in which one of the two pilots is unable for various reasons to perform his duties in the pilot's seat.

The present invention is not restricted to application in “fly-by-wire” control systems. It can also be used in commercial aircraft in which the control devices in the cockpit are directly connected mechanically, i.e., as a rule by cables, with the control surfaces of the aircraft. In these control systems, a flight computer is, to be sure, also usually present; however, it no longer has the task of converging electronic signals from the control devices and forwarding them to the control surfaces. In these control systems, the electrical connection line from the control devices to the flight computer 10 depicted in FIG. 2 is then omitted, as is the electrical connection line from the flight computer 10 to the control surfaces. However, even in these control systems that are not based on “fly-by-wire” technology, an autopilot that acts on the mechanical devices on the basis of destination data entered and adjusts the control surfaces in a specific manner may be present. Even this autopilot can then be activated and deactivated to switch between automatic and manual flight operation.

1. Security system for the control of an aircraft switchable between automatic and manual flight operation, characterized by
means (3) to detect physical characteristics of individuals,
means (11-14) to prevent the activation of manual flight operation or to switch from manual to automatic flight operation or to deactivate manual flight operation, if the physical characteristics detected by the detection means (3) do not match predefined physical characteristics.

2. Security system according to claim 1, characterized in that
the physical characteristics are the body weight of an individual, and
the detection means (3) include a weight sensor, in particular a scale.

3. Security system according to claim 2, characterized in that
the scale is integrated into the pilot's seat of the aircraft as a seat scale.

4. Security system according to one of the preceding claims, characterized by
means (12) to store the data about the physical characteristics communicated by the detection means (3).

5. Security system according to one of the preceding claims, characterized by
means (13) to compare the data delivered by the detection means (3) with predefined data.

6. Security system according to claims 4 and 5, characterized in that
the predefined data are data stored in advance in the storage means (12).

7. Security system according to one of the preceding claims, characterized by
an automatic and a manual flight operation mode, whereby one of the two operating states is always set.

8. Security system according to claim 7, characterized by
an autopilot computer unit (1) and means (14) to activate/deactivate the autopilot computer unit (1).

9. Security system according to one of claims 1 or 4 through 8, characterized in that
the physical characteristics are the iris of an individual, and
the detection means (3) include an image sensor for optical detection of the iris.

10. Security system according to one of claims 1 or 4 through 8, characterized in that
the physical characteristics are the voice of an individual, and
the detection means (3) include a microphone, and a
voice analysis unit.

11. Security system according to one of claims 1 or 4 through 8, characterized in that
the physical characteristics are provided by a fingerprint and/or handprint of an individual.

12. Security system according to a plurality of claims 2 and 9 through 11, characterized in that
the physical characteristics are provided by a plurality from the group body weight, iris, voice, fingerprint and/or handprint.

13. Control system for an aircraft, including a security system according to one or a plurality of the preceding claims.

14. Control system according to claim 13, characterized in that
the control system includes an electronic “fly-by-wire” control system.

15. Control system according to claim 13, characterized in that
the control system is a substantially purely mechanical control system.

16. Process to prevent manual control of aircraft by unauthorized individuals, with the process steps
a) detection of specific physical characteristics of the operator;
b) prevention of manual flight operation, if the physical characteristics detected do not match prespecified physical characteristics.
